(19) United States
(12) Patent Application Publication
(10) Pub. No.: US 2003/0033608 A1
(43) Pub. Date: Feb. 13, 2003

(54) BTI RF module with filtering

(75) Inventors: Kevin T. Chang, Doylestown, PA (US); Richard Moore JR., Harleysville, PA (US); Jay Strater, Jamison, PA (US)

Correspondence Address: VOLPE AND KOENIG, PC, DEPT MOT, SUITE 400, ONE PENN CENTER, 1617 JOHN F. KENNEDY BOULEVARD, PHILADELPHIA, PA, 19103, US

(73) Assignee: General Instrument Corporation, Horsham, PA

(21) Appl. No.: 09/927,841

(22) Filed: Aug. 10, 2001

(51) Int. Cl. H04N 7/173

(52) U.S. Cl. 725/119; 725/120; 725/129; 725/106; 725/127; 725/118

(57) ABSTRACT

A cable system having a splitter for coupling a drop interface to a cable modem and pass-through to a home interface. The pass-through is provided with an RF module having separate forward and return paths to selectively provide unimpeded, partially impeded and fully impeded cable service in the forward and return paths. Amplifiers in the forward and return paths are controlled to avoid excessive insertion loss and to provide power equalization in the return path to limit ingress noise to the home.

### BACKGROUND

The present invention relates to Broadband Telephony Interfaces (BTI) and more particularly to remotely configured filters provided in RF modules employed within BTIs.

The present invention is advantageous for use in systems that employ a bi-directional communication system. Such bi-directional communications capability can easily be provided through the utilization of existing cable TV (CATV) networks which have more than the necessary capability for providing such services. Voice service (i.e., telephony) may be provided through the employment of Internet protocol (IP) which enables the use of a common infrastructure for both voice and data, i.e., through the use of a hybrid fiber coax (HFC) infrastructure.

Using the IP to provide voice service, connections must be capable of being provided for subscribers which are part of the IP network as well as allowing calls to non-IP subscribers through the public switching telephone network (PSTN).

FIG. 1 is a simplified block diagram showing a system for providing telephony service over an IP network. The system 10 shows a typical home subscriber 12 which is provided with a BTI (Broadband Telephony Interface) 14 providing the consumer with a connection between their telephony appliances such as phones, fax machines and modems. FIG. 1 shows a home telephone 16 and a personal computer (PC) 18 provided with a modem. The BTI 14 provides Broadband telephony over the IP network. BTI 14 provides telephony and data services which is at least comparable to currently available services and has the further capability of extending these services to accommodate future applications.

BTI 14 communicates with the correlation unit C provided as part of the regional data center architecture 60, using the SGCP (Simple Gateway Control Protocol) which is a standard forward managing course set up in a voice over IP (VoP network) or MGCP (Media Gateway Control Protocol which is a merger of SGCP and IPTC, i.e. Internet protocol device control).

BTI 14 collects digits and other events which are reported to the Call Agent D in unit 60 as well as responses to requests from the Call Agent D. The BTI 14 digitizes audio from the connected phone 16, modem 18 or a fax machine (not shown), processes the audio following the coding scheme such as G.711 (pulse code modulation, i.e PCM) and transmits the digitized data to the connector device 22 using RTP (Real Time Protocol used for stream audio in the VoIP).

BTI 14 receives its provisioning including the Call Agent FQDA (Fully Qualified Domain Name) for each line, at a power-on condition by way of DHCP (Dynamic Host Control Protocol which is used to dynamically assign IP addresses to terminals and provide additional information typically required at terminal boot time). Changes to the provisioning and configuration and reporting status are accomplished by way of the SNMP (Simple Network Management Protocol, which is an industry standard protocol for the management of network elements and is the protocol used for configuration and control of BTIs).

Each BTI such as BTI 14, has integrated therein a high speed cable modem CM and comprises 4 telephony ports for telephony communications as well as one IJ 45 for 10 Base T Ethernet data communications.

The BTI is defined herein as a device that provides an interface to IP telephony service which is provided employing an HFC Network 22 (Hybrid Filter Coax, a network architecture where content is carried using fiber for long hauls and coax cable in the neighborhood of the subscriber). A fiber node 22 couples the coax cable 19 to the fiber network 24, 26 for two-way communications (i.e. upstream, downstream) between the subscriber 12 and the system through an HCLP architecture unit 30, SONET ring 50, regional data center architecture 60 and an IP back bone 80 and PSTNs (Public Switch Telephone Networks) 90 and 100 which are coupled to the Regional Data Center Architecture (RDCA) 60 through connectivity zone 70. The hub connectivity architecture 50 comprises a SONET (synchronous optical network) ring capable of interconnection to any number of additional networks.

There exists a need to provide flexibility for a mix of upstream and downstream filters in a residential gateway while minimizing both size and cost of the Gateway. An RF module (hereinafter RFM) with amplification allows the above requirements to be met since the module has separate upstream and downstream paths which are needed and which advantageously accommodate themselves to several upstream and downstream filter options. An RFM is chosen with separate upstream and downstream paths to provide independent upstream and downstream amplification in order to avoid excessive insertion loss and provide up stream power equalization for limiting ingress noise from the home.

SUMMARY

The present invention is directed to a method and system for incorporating upstream and downstream filters and filter relays in a residential telephony Gateway to provide unimpeded, partially impeded and fully cut-off cable service to and from a residential Gateway. Remote configuration of the filters is provided by residential Gateway element management. The filter settings also serve to cut off ingress noise generated in the home when ingress monitoring is incorporated in the residential Gateway's RFM. The relay settings for the filters are preferably controlled by SNMP (Simple Network Management Protocol which is an industry standard protocol for the management of network elements and is the protocol used for configuration and control of BTIs) and MIB (Management Information Base) settings.

### BRIEF DESCRIPTION OF THE DRAWING(S)

FIG. 1 is a simplified block diagram showing an IP system which may utilize the present invention to great advantage.

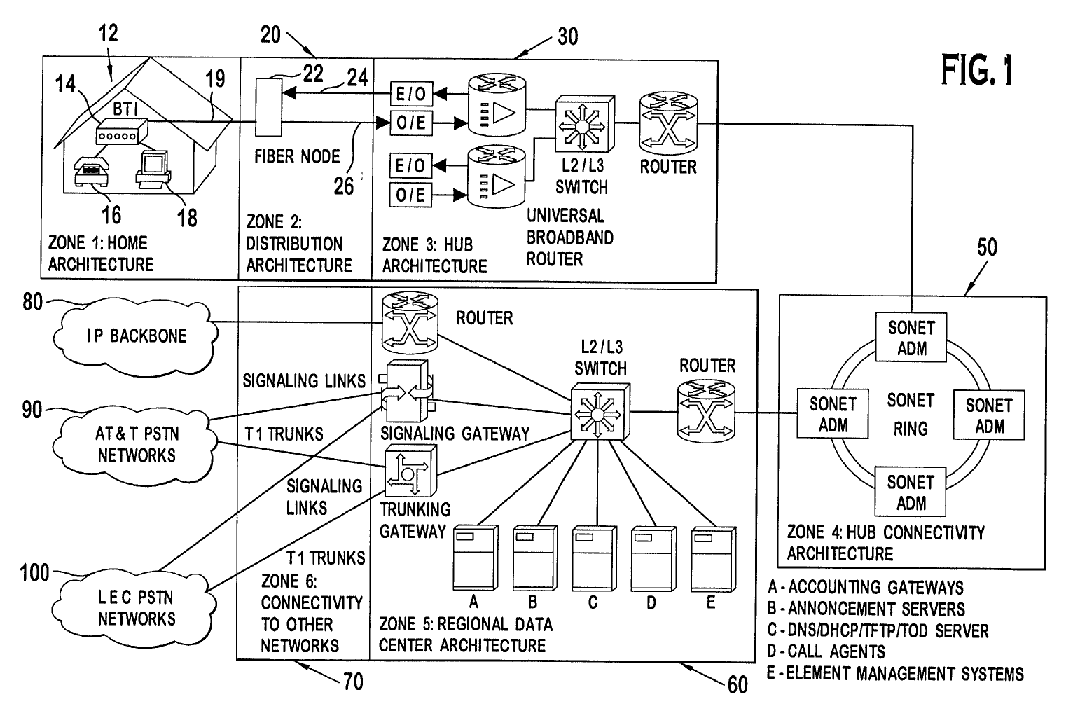

FIG. 2 shows a simplified block diagram of an Rf module.

FIG. 3 shows a simplified block diagram of a RF module providing filtering.

### DETAILED DESCRIPTION OF THE PREFERRED EMBODIMENT(S)

RF modules are required in wall mount BTIs for splitting RF signals between internal processing components (for telephony) and HSD as well as a pass-through line to/from the home.

The two types of RFMs for wall mount BTI are:

1) RFM without filter configuration and amplification,

2) RFM with filter configuration and amplification of the RF pass-through to the home.

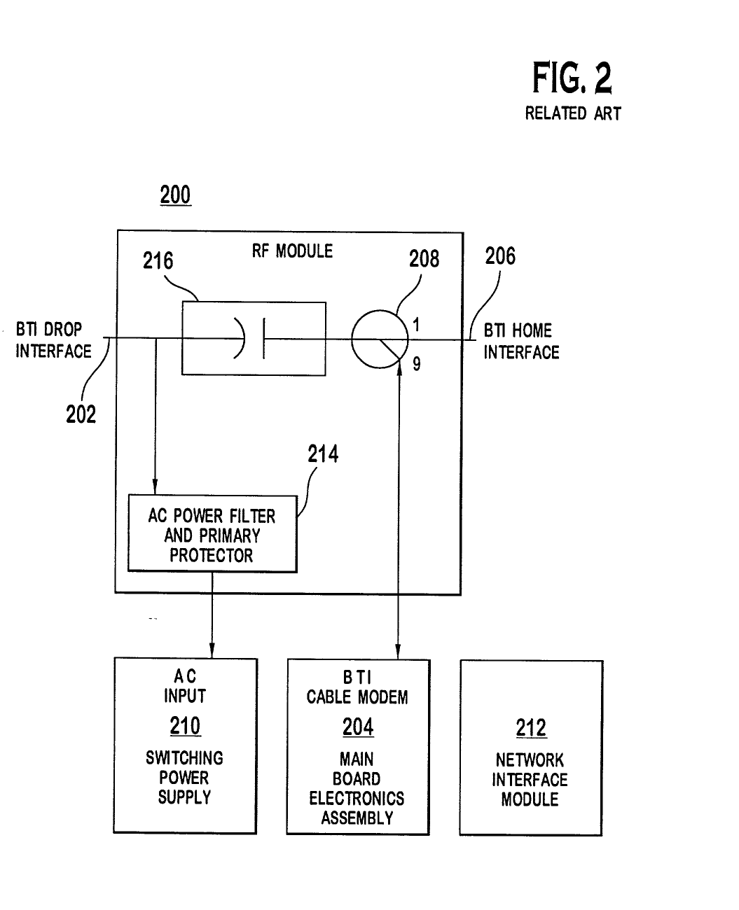

FIG. 2 shows the passive RFM 200 without filter configuration, which splits the RF path from the BTI drop interface 202 into two lines, one for the Cable Modem 204 in the BTI (BTI CM) and one for the BTI output to the home interface, the latter line being referred to as the pass-through line. RFM 200 provides a nominal loss of under 2 dB between the BTI home interface 206 and the drop interface 202 for frequencies in the range between 5 and 900 MHz. RFM 200 provides nominal loss from the BTI CM to the drop interface 202 of under 10 dB for frequencies between 5 and 900 MHz.

RFM 200 includes a 1/9 directional coupler 208 which meets the path loss requirements set forth above. The BTI derives its power from the cable network through a switching power supply (SPS). The switching power supply (SPS) 210 and the network interface module (NIM) 212 are shown for interface references. An AC power filter and primary protector 214 are provided between the drop interface 202 and the AC input. Capacitor 216 is coupled between interface 202 and the input to the directional coupler 208 to provide AC coupling.

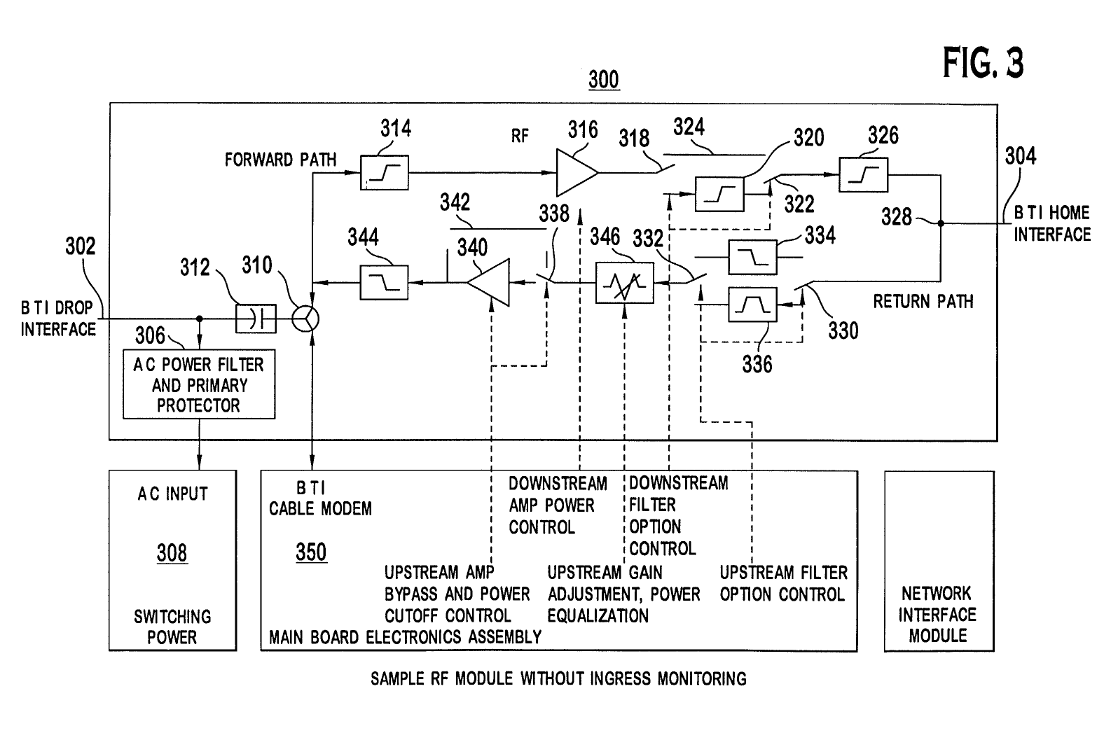

Briefly, the active RFM 300, shown in FIG. 3, provides a local cable modem interface (BTI CM) 350 and pass-through line as is the case with passive module 200, as well as upstream and downstream amplification and filtering. Loss from the drop interface to BTI CM 350 is under 5 dB for frequencies between 5 and 100 MHz. RFM 300 provides a pass-through line having separate upstream and downstream paths to provide separate and independent upstream and downstream processing. The upstream pass-through line (i.e., “Return Path”) has a 5-42 MHz or 5-48 MHz band depending on customer requirements. The downstream pass-through line (i.e., “Forward path”) has a 52 MHz to one GHz bass band. Splitter 310 is chosen to provide lower drop interface to BTI CM path loss as compared to splitter 208 shown in FIG. 2.

In the downstream pass-through line, RFM 300 provides amplification for 6 dB gain from the BTI drop interface 302 to the home interface through amplifier 316. There is also an option for no filtering, high pass filtering or complete cut-off of the downstream path Downstream amplifier 316 is controlled by the Cable Modem (BTI CM) 350 and is turned off to save power when the downstream path is cut off from service, such as video or cable modem service, to the home. The cut-off frequency for the high pass filter 320 is preferably customer selected at the time of manufacturing and is typically 450 or 550 MHz to allow analog video channels to be cut-off from service to the customer. The on/off state of amplifier 316 and the filtering option is setable by the BTI CM but is controlled by the BTI EMS (Element Management Server) which receives configuration control from the network.

The state of the amplifier 316 determines the net power draw and the filter/cut-off selection of filter 320 impacts in-home video and CM service.

The upstream gain adjustment and power equalization level are respectively adjusted under control of the BTI CM 350 by adjustment of attenuator 346 and amplifier 340. The upstream amplification and bypass state are controlled by BTI CM 350 which operates relay 338, to determine upstream gain and ingress mitigation.

The relay states of the relays are controlled in accordance with SNMP (Simple Network Management Protocol—an industry standard protocol for the management of network elements which is used for configuration and control of all BTIs). Amplifier states and attenuation are also controlled by the BTI CM.

The BTI CM modifies the downstream amplifier and/or filter relay state in the RFMs having amplification when the change in the amplifier and/or relay states are received. The upstream amplifier, amplifier bypass, attenuator and/or filter relay are modified when a change in the amplifier state, amplifier bypass state, attenuation level and/or filter relay state are received either at provisioning or subsequently.

When upstream attenuation is employed, the level of attenuation depends on the maximum upstream level from the home interface 304, and the state of the upstream amplifier 344 and bypass 342.

Considering FIG. 3 in greater detail, RFM 300 is coupled between the BTI drop interface 302 and the home interface 304 and includes a power filter 306 coupled between 302 and the AC input of SP 308. A splitter 310 is coupled to the input 302 through a capacitor 312 which acts as an AC coupler and decouples DC. Splitter 310 divides the line coupled to BTI drop interface 302 into a line coupled to the cable modem in the BTI (BTI CM) and the bypass line to the home interface 306.

The BTI CM is directly coupled to one terminal of the splitter 310 while the separate forward and return paths are coupled in common to the other terminal of splitter 310. The forward path includes a highpass filter 314, amplifier 316 and relay 318 for selectively coupling the input end of high pass filter 320 in the forward path. Relay 322 cooperates with relay 318 to selectively couple either low pass filter 320 or bypass conductor 324 into the forward path or alternatively totally isolate and open the forward path. A highpass filter 326 is coupled between relay 322 and the common terminal 328. Common terminal 328 is coupled to the BTI home interface 304 which is in turn coupled to the subscriber's equipment such as a television, set top box, modem, etc.

The return path includes a pair of relays 330, 332 for selectively coupling either a highpass filter 334 or a midrange filter 336 into the return path. Relay 338 selectively couples either amplifier 344 or bypass conductor 342 into the return path or alternatively totally isolates and opens the return path. A highpass filter 344 is coupled in common to the same splitter terminal as the forward path. Gain adjustment element 346 is coupled between relays 332 and 338.

The BTI CM controls the relays 330 and 332 according to SNMP to selectively insert either highpass filter 334 or midpass filter 336 into the return path or to open the return path. The BTI CM further controls the relays 318 and 322 to selectively either place bypass conductor 324 or lowpass filter 320 into the forward path or to open the forward path.

The BTI CM further controls upstream gain and power equalization by control of adjustable attenuation element 348 and further controls the upstream amplifier 340 as well as relay 338 to selectively insert the bypass conductor 342 into the return path and to exert power cutoff control when the bypass conductor is coupled into the return path or when the return path is open.

It can clearly be seen that the present invention provides flexibility for a mix of upstream and downstream filters in a residential gateway while at the same time minimizing gateway size and cost. An active RF module (RFM) with filtering allows both of the above-mentioned goals to be met do to the fact that it is provided with separate upstream and downstream paths which are required in order to separate upstream and downstream filter operations. Providing the RF module with separate upstream and downstream amplification avoids insertion loss and provides upstream power equalization to limit ingress noise from the home. The filters and filter relays provided in the residential telephony gateway selectively provide unimpeded, partially impeded and fully cut-off cable service to and from the home coupled to a gateway. Remote configuration of the filters is obtained by way of residential gateway element management. The filter settings also serve to cut-off ingress noise generated in the home.

The choice of downstream band pass filtering for impeded pass-through filtering may be chosen and installed at the time of manufacturing. Filter relay settings may be controlled by way of SNMP (Simple Network Management Protocol) MIB.

What is claimed is:

1. A cable system having an RF module coupled to provide bi-directional communication between drop interface and a home interface;
said RF module having upstream and downstream paths;
at least the downstream path having filters; and
a controller for selectively providing unimpeded; partially impeded and full cut off of cable service in the downstream path.

2. The cable system of claim 1 wherein relays in the downstream path are operated by the controller to obtain unimpeded, partially impeded and fully cut off cable service.

3. The cable system of claim 2 wherein a filter for impeding frequencies above a given frequency is selectively coupled into the downstream path by said relays to pass only frequencies below said given frequency.

4. The cable system of claim 2 wherein the controller operates said relays to provide an open circuit in the downstream path to fully cut off cable service in the downstream path.

5. The cable system of claim 2 wherein the downstream path is provided with a bypass conductor selectively coupled in the downstream path to provide unimpeded cable service to the subscriber.

6. The cable system of claim 1 further comprising:
an adjustable amplifier in the downstream path operated by said controller for providing signal amplification to compensate for insertion loss.

7. A cable system having an RF module coupled to provide bi-directional communication between a drop interface and a home interface;
said RF module having upstream and downstream paths;
at least the upstream having filters; and
a controller for selectively providing unimpeded partially impeded and full cut off of cable service in the upstream path.

8. The cable system of claim 7 wherein relays in the upstream path are operated by the controller to obtain unimpeded, partially impeded and full cut off cable service in the upstream path.

9. The cable system of claim 6 wherein a filter for impeding frequencies below a first frequency and above second higher frequency is selectively coupled into the downstream path by said relays to pass only frequencies between said first and second frequencies.

10. The cable system of claim 8 wherein the controller operates said relays to provide an open circuit in the upstream path to fully cut off cable service in the upstream path.

11. The cable system of claim 8 wherein the upstream path is provided with a high pass filter selectively coupled in the upstream path to provide unimpeded cable service in the upstream path.

12. The cable system of claim 7 further comprising an adjustable amplifier in the upstream path operated by the controller to provide power equalization to limit ingress noise in the upstream path.

13. A cable system have an RF module coupled to provide bi-directional communication between a drop interface and a home interface;
said RF module having upstream and downstream paths;
each path having filters; and
a controller for selectively providing unimpeded, partially impeded and fully cut off cable service in the upstream and downstream paths.

14. The cable system of claim 13 wherein relays in the upstream and the downstream paths are operated by the controller to selectively obtain unimpeded, partially impeded and fully cut off cable service.

15. The cable system of claim 14 wherein a filter for impeding frequencies below a first frequency and above a second frequency is selectively coupled into the upstream path by said relays to pass only frequencies between said first and second frequencies.

16. The system of claim 13 wherein the controller operates said relays to selectively provide an open circuit in the upstream and downstream paths to fully cut off cable service in the upstream and downstream paths.

17. The cable system of claim 13 wherein the upstream path is provided with a bypass conductor selectively coupled in the upstream path to provide unimpeded cable service in the upstream path.

18. The cable system of claim 15 wherein the upstream path is provided with an amplifier controlled by a cable modem to provide power equalization to limit ingress noise from the home interface.

19. The cable system of claim 15 wherein the downstream path provided with an amplifier controlled by a cable modem to avoid excessive insertion loss.

20. A cable system comprising:
a cable modem;
a splitter providing a pass-through path between a drop interface and a home interface and for coupling the cable modem to the drop interface;
said pass-through path being divided into forward and return paths;
said forward and return paths having filters for cutting off selected frequencies to selectively control the provision of cable service in said paths.

21. A cable system according to claim 20 further comprising relays in said forward and return paths under control of the cable modem for selectively controlling the unimpeded, partially impeded, and fully impeded cable service in said forward and return paths.
